(19) United States
(12) Patent Application Publication
(10) Pub. No.: US 2011/0153613 A1
(43) Pub. Date: Jun. 23, 2011

(54) INFORMATION SEARCH APPARATUS AND METHOD USING LOCATIONAL/SOCIETAL RELATION-BASED AUTOMATIC CATEGORY GENERATION

(75) Inventor: Hoon-Ki LEE, Daejeon (KR)

(73) Assignee: ELECTRONICS AND TELECOMMUNICATIONS RESEARCH INSTITUTE, Daejeon (KR)

(21) Appl. No.: 12/972,654

(22) Filed: Dec. 20, 2010

(30) Foreign Application Priority Data
Dec. 21, 2009 (KR) 10-2009-0128244

(51) Int. Cl. G06F 17/30

(52) U.S. Cl. 707/740; 707/E17.089

(57) ABSTRACT

Disclosed herein is an information search method using automatic category generation, which automatically generates a category related to a keyword entered by a user, constructs an ontology for processing menu information based on the searched results, and provides a customized menu suitable for the use of the keyword. More particularly, the present invention relates to an apparatus and method for automatically generating keyword-related categories, which automatically classifies menu information related to the results of search of information using a keyword entered by a user on the basis of locational/societal relations.

### CROSS REFERENCE TO RELATED APPLICATION

This application claims the benefit of Korean Patent Application No. 10-2009-0128244, filed on Dec. 21, 2009, which is hereby incorporated by reference in its entirety into this application.

### BACKGROUND OF THE INVENTION

1. Technical Field

The present invention relates generally to an information search apparatus and method using locational/societal relation-based automatic category generation. More particularly, the present invention relates to an apparatus and method for automatically generating keyword-related categories, which automatically classifies menu information related to the search results of information corresponding to a keyword that was entered by a user on the basis of locational/societal relations.

2. Description of the Related Art

Typical navigation or search (retrieval) websites are configured to classify a user's desired information such as Point of Interest (POI) into categories in advance and allow the user to select desired data from an information list. This scheme is characterized in that all information provision methods are provided equally regardless of the types of users, so that a method of allowing each user to select data depending on the user's desired locational and societal (social) relations and the user's personal characteristics is not supported. The scheme is only a method of simply classifying predetermined information into menu forms and collectively providing classified information. Further, selectable contents resulting from information search are configured around a provider, rather than around a user, and thus there is a probability of including undesired information.

From the standpoint of the user, he or she knows neither the classification system of all information, nor a menu item in which relevant information is included. Accordingly, when the user enters a specific keyword regarded as being related to desired information and wants to obtain a search method including the specific keyword, it is impossible to provide an information provision service in the collectively-set menu scheme, as described above.

The development of the Internet and digital media is making content providers distribute various types of digital content using a variety of methods over the Internet. For example, videos including movies or music have been played over the Internet using streaming technology, and the played music is transferred over the Internet in the form of MP3 files. Further, text-format content which was viewed only in paper books is downloaded in the form of Electronic-book (E-books) over the Internet, and the content of most of the existing TV and radio programs can be viewed again over the Internet.

The above-described conventional content provision service is configured to allow a user to search for desired content using a content search function and purchase the content after a large amount of content to be provided to users has been prepared. That is, since a content provider provides a user-led content search function, the user can use the desired content only when the user has previous knowledge about the content, or perform a real-time test such as prelisten (or preview) on the content.

This scheme is advantageous in that the user can select his or her desired content for himself or herself, but is disadvantageous in that it is difficult for the user to gain access to new content, or content that suits the user's preferences, but could not have been experienced by the user before. That is, since the user must select content suitable for him or her from a large amount of content, he or she inevitably searches for content only within the range of his or her knowledge and limitedly enjoys the content.

For this reason, content providers have provided a function of recommending predetermined content lists even if the user does not personally search for content. That is, content providers have provided predetermined content lists in accordance with a ‘method of recommending pieces of content having a format similar to content belonging to the user's favorites’ in consideration of the relationships among pieces of content.

For example, in content provision services, predetermined content lists which are classified according to feeling (love, pleasure, farewell, etc.), genre (the latest music, dance, ballad, etc.), age (teenagers, twentieths, thirties, etc.), season/time (spring, summer, fall, winder, etc,), weather (sunny day, cloudy day, rainy day, etc.), place (office, karaoke, the scene of Commercial Film (CF), etc.), etc. are generated and recommended to users.

Such a content provision service is disadvantageous in that, even if a relevant content list is selected from a large amount of content and is recommended to the user, the content list is unilaterally provided by the content provision service without taking into account the user's situational context or preferences.

Meanwhile, according to the recent tendency for the viewpoint of the web to develop from a technical into a social viewpoint, content providers have recently paid attention to content provision services in which networks are configured using the formation of relationships between users and in which the daily affairs or concerns of the users can then be shared and communicated over the network.

For example, some content providers have provided a service of, when the user enters the name of his or her preferred singer, randomly recommending songs of other singers that have traits similar to that of the singer entered by the user, as well as songs of the entered singer, on the assumption that the user will also like the songs of the other singers having similar traits.

In particular, content providers pay attention to the fact that when a network is configured among users having the same hobbies or ways of thinking, the network can explosively expand in a short period of time, and therefore think that a content provision service based on the network among users can be a new profit model.

For this reason, in the conventional content provision service, there is a need to propose a service for providing optimal content suitable to each user by recommending content suitable for the user's situational context as well as by referring to the content enjoyed by persons having similar traits based on the similarity among the content present in the relationships among users.

In particular, it is difficult for each user to select content suitable for his or her preferences from a large amount of content because he or she is not usually familiar with the content. Accordingly, the user is demanding a service that recommends content that is suitable for his or her preferences and that desirably complies with his or her situational context.

Meanwhile, a context awareness service is a representative one of customized services using ubiquitous computing. Ubiquitous computing is a core paradigm of the future information society that intends to freely use networks without regard to place (anywhere), time (anytime) or the device (any device).

Ubiquitous computing is adapted to provide various types of user-centered personalized services by connecting all environmental elements around human lives over a wired or wireless network. That is, ubiquitous computing refers to an environment in which the user can freely access the network without regard to the place in the state in which the user is not aware of computers or networks. In order to construct such a ubiquitous computing environment, computing and communication functions must be added to all electronic devices used in real life. This means that each device has a unique address and is connected to a wideband network over the wired or wireless network.

Alongside the development of technology, the performance of semiconductors and the electronic devices that include such semiconductors is continuously improving, but the prices of the semiconductors and the electronic devices are rapidly decreasing. Further, as the popularization of the wireless Internet has been gradually activated, an environment where ubiquitous computing can be implemented has been gradually formed. The opening of the ubiquitous age is not a specific event in the future any more, but is becoming reality. That is, it is becoming possible to remotely control the operation of a heating apparatus provided indoors by using a watch worn on the wrist outdoors, or to remotely receive a notification of a specific event when a specific event takes place indoors.

A context awareness service is a service based on the fact that human beings have intelligence, and interact with each other and make decisions based on the surrounding contextual information. That is, such a context awareness service is configured to provide a service customized for each user in such a way that electronic devices for implementing ubiquitous computing collect information about users and their surrounding contexts which are continuously changing, and analyze the collected information. In order to implement such a context awareness service, the technology for collecting various types of information such as the preferences of and physical conditions of each user and providing service content most suitable to the current situational context of the user based on the collected information is required.

Most navigation or information search websites are configured to receive a specific keyword or to allow the user to search menu items, which are preset by a service provider to implement information search, for desired information. In this case, the user must be familiar with which menu items are provided by the service provider. Further, even if a specific keyword is entered, the navigation or information search websites are configured to simply provide information from among all pieces of content, and thus there is a limitation when the user is provided with an optimal problem solution service using the searched results.

### SUMMARY OF THE INVENTION

Accordingly, the present invention has been made keeping in mind the above problems occurring in the prior art, and an object of the present invention is to provide an information search method using automatic category generation, which enters a specific keyword via a Social Network Service (SNS) or a search website and automatically generates a category related to the keyword, thus providing a desired information menu service to a user.

Another object of the present invention is to provide an information search method using automatic category generation, which can provide an optimal menu for information desired to be found by a user on the basis of information having societal relations with a specific location.

A further object of the present invention is to provide an information search method using automatic category generation, which enters a specific keyword and automatically generates a related menu, thus minimizing the additional time and additional information search costs that the provision of unnecessary information causes a user to have.

Yet another object of the present invention is to provide an information search method using automatic category generation, which can generate a menu corresponding to any keyword when a user enters the keyword, by automatically generating a user-customized category, and can provide various types of information provision services from a selected menu item.

In accordance with an aspect of the present invention to accomplish the above objects, there is provided an information search method using automatic category generation, wherein a category related to a keyword entered by a user is automatically generated, an ontology for processing menu information is constructed based on results of search, and a customized menu suitable for a use of the keyword is provided.

In accordance with another aspect of the present invention to accomplish the above objects, there is provided an information search method using automatic category generation, including receiving profile information and locational information of a user from the user; receiving a keyword from the user; classifying a category of the received keyword by analyzing morphemes of the keyword; generating a menu by inquiring about a classification system; and generating a product information list using the locational information and the profile information of the user, and displaying a recommendation list based on the product information list.

Preferably, the information search method may further include, if a specific keyword is not exactly identical to relevant information, detecting whether information related to the specific keyword is present, based on an ontology structure enabling prediction of information similar to the keyword.

Preferably, the classification system may be configured such that classification items are controlled to be linked to basic menus, and detailed items corresponding to each classification item are displayed.

Preferably, the classification system may be configured in an Extensible Markup Language (XML).

Preferably, the classification system may determine a usable range of each keyword by performing analysis of morphemes of the keyword and examination of similarity, based on an ontology.

In accordance with a further aspect of the present invention to accomplish the above objects, there is provided an apparatus for automatically generating keyword-related categories, including a DB (psychographics) for storing profile information of a user, a locational information provision module for providing locational information of the user, a product information DB for storing product information, and an automatic category generation engine for generating a product information list using the information stored in the product information DB, based on the user profile information and the locational information of the user, and extracting a recommendation list based on the product information list.

Preferably, the automatic category generation engine may further generate a keyword ontology configured to enable prediction that similar information is included, and a category code list configured to examine similarity of the keyword and automatically generate menu information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of an automatic category generation system;

FIGS. 2 and 3 are diagrams showing examples of the definition of a classification system for automatically generating categories from information provided as a result of the search of tour information presented according to the present invention;

FIGS. 4 and 5 are diagrams showing schema structures for representing psychographic information provided in consideration of both the properties of a user and the characteristics of tour information from tour information provided by the automatic category generation system;

FIGS. 6 and 7 are diagrams showing examples of the transmission of menu information represented to the user via an automatic category generation function; and

FIG. 8 is a flowchart showing a process for performing an information search method using automatic category generation provided according to the present invention.

### DESCRIPTION OF THE PREFERRED EMBODIMENTS

In order to accomplish the above objects, an information search system and method using automatic category generation according to an embodiment of the present invention is provided. The present invention includes a method of, when an information service is provided using the input of any keyword, generating a category related to the keyword and providing the category to a user, thus providing optimal search information. Further, the configuration diagram of the present invention will be described using a service called a tour information search service for the sake of clear understanding of embodiments of the present invention.

Hereinafter, embodiments of an information search method and system using automatic category generation according to the present invention will be described in detail with reference to the attached drawings.

The term “social network” refers to a set of friends, fellow workers, or persons, organizations or other social entities that are connected via various social relations such as the relation of information exchange. Recently, as the number of services which allow each user to freely post his or her own personal information on web-based spaces connected over the network, such as blogs or online cafés, has increased alongside the development of the Internet, research into those aspects of social networks which are focused on the relationships among users has been actively carried out.

These users form virtual communities in various fields such as education, politics, and economy as well as in simple social respects, and thus social networks have become established as having an important portion in modern society.

The object of Social Network Analysis (SNA) is to discover specific patterns, which have not yet been revealed, on the basis of the relationships among those social entities. As described above, research into social networks has been continuously conducted across a wide range of fields, and research into various applications related thereto has been carried out.

C. Chen analyzed and visualized, on the basis of lists (co-citation) of other materials referred to by authors of materials in an electronic library, relations with the other materials. Further, relations between co-authors of documents were analyzed, and furthermore a person having the power of influence was found in a co-author network.

Internet social networking services that have been commercialized include services provided by LinkedIn, Linknow, etc. which are business-oriented social networking websites for mainly forming the networks of expert groups, and services provided by orkut, MySpace, facebook, cyworld, etc. which are websites for forming social networks so as to maintain and extend personal friendships and to share information among the persons.

There are a variety of approaches to analysis in proportion to the variety of research and application fields. Recently, with the development of a semantic web paradigm, the use of an ontology has been greatly popularized as one approach to social network modeling and analysis.

The advantages that can be obtained by using an ontology for social network modeling and analysis are as follows. First, an ontology is generally used to describe concepts related to a given domain and mutual relationships between them and provide a specification of the relationships. A social network is coincident with the typical object of an ontology in that it has an object of providing a specification of social relationships between individual entities.

Further, since an ontology does not permit the modeling of compatible or inconsistent information, the validity of information can be guaranteed.

Finally, an ontology enables new information to be obtained by inferring the new information on the basis of a suitable rule and an inference mechanism. Such an inference mechanism can be used to discover a new relation between entities which did not exist before.

Examples of the analysis of social networks using an ontology and applications related thereto are as follows. P. Mika collected social network data represented by an ontology, and analyzed and evaluated social networks using the collected data. P.O. Wennerberg used an ontology and the analysis of a social network as one approach to discover knowledge from a knowledge base in a specific domain.

Further, Aleman-Meza used an ontology so as to effectively analyze a conflict-of-interest relationship occurring during a procedure for combining two different social networks. Research into a technology for modeling users using an ontology and analyzing relations among the users for the purpose of recommending suitable information to the users is currently being carried out.

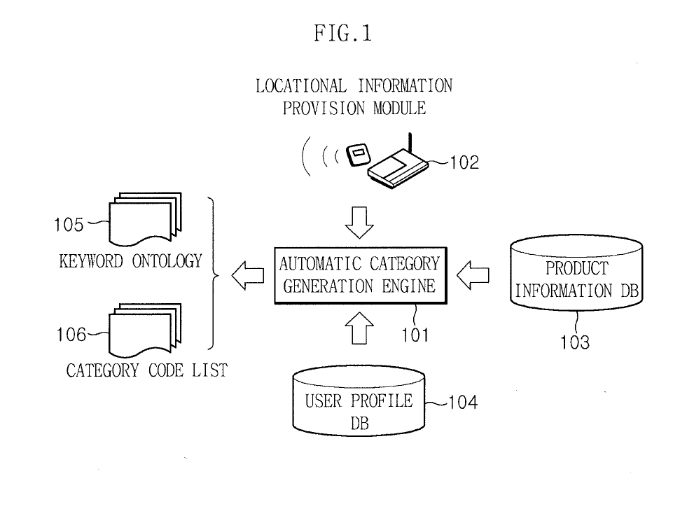

FIG. 1 is a diagram showing the construction of a system for automatically generating to keyword-related categories based on locational/societal relations.

The present construction is configured such that categories are generated using various types of information collected by an automatic category generation engine 101 and a keyword entered by a user. Information about a user who requires a service and information about an environment in which the user requires the service are input using the user profile information from the user profile DB 104 and locational information of the user from the locational information provision module 102 so as to obtain optimal results required by the user.

Various types of user profiles from the user profile DB 104 collected via psychographics, as well as the locational information of the user detected using the locational information from the locational information provision module 102, can be detected. In order to transmit the optimal results to the user, recommendation information from the product information DB 103 is also arranged and processed into a database (DB) using psychographics so that actually provided information, as well as automatically generated categories, can be differently provided as information customized for each user.

In order to provide the user information and the recommendation information from the product information DB 103, data is configured so that even if a keyword is entered by a user so that the information desired by a user can be processed, the similarity 105 of the keyword to relevant information is examined and the keyword is mapped to the data using an ontology with the category code list 106 required to automatically generate menu information.

Such a structure can be implemented by an ontology structure enabling the prediction that a specific keyword will have similar information even if the specific keyword does not exactly match relevant information. In this way, the structure is reconstructed such that both service items by which keyword information entered by the user is provided, and extraction menus which can be generated using the similarity and the relevant information even if the entered information is not information that cannot be exactly searched for, can be automatically generated.

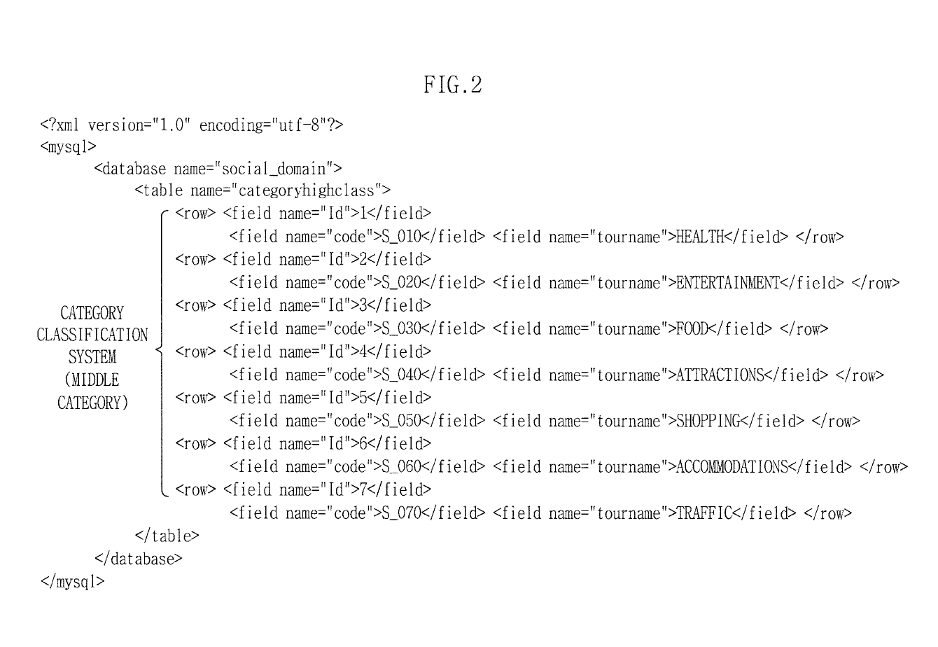

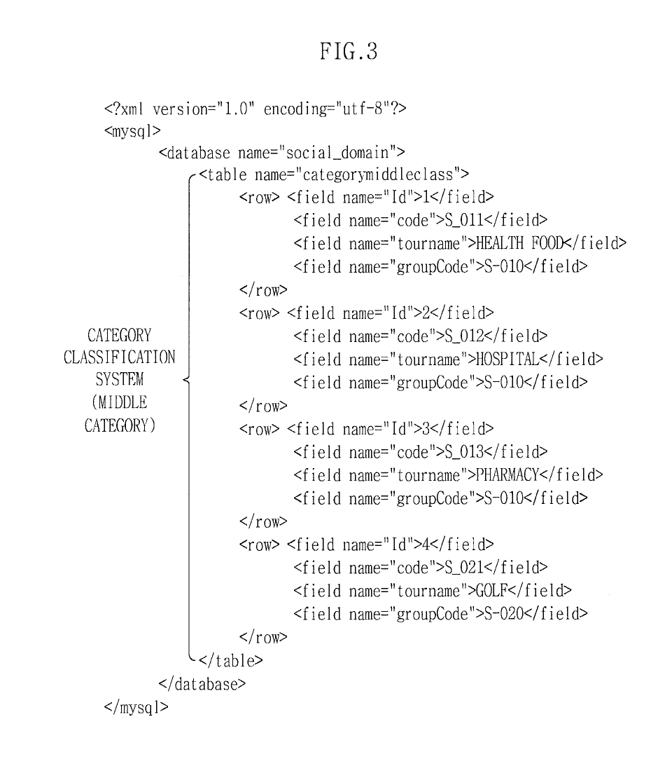

FIGS. 2 and 3 are diagrams showing examples of the definition of a classification system for automatically generating categories from information provided as a result of the search of tour information presented according to the present invention.

Referring to FIGS. 2 and 3, each classification system can be implemented by extracting information related to a keyword entered by a user using a similarity examination performed on the keyword information, and by classifying the extracted information.

Further, in each classification system, classification items are controlled to be linked to basic menus, as shown in FIG. 2, and detailed items corresponding to each classification item are displayed, as shown in FIG. 3. In this case, each item is divided into a middle category and a low category, thus enabling more exact information to be provided to the user.

This subdivision of the classification system is advantageous in that items required by the user can be flexibly generated according to the service during the procedure for automatically generating categories, and can be limited to a specific service field.

Each classification system code is configured in Extensible Markup Language (XML), which enables compatibility and portability to be retained. Classification system code enables the usable range of individual keywords to be set by the analysis of the morphemes of each keyword and by the similarity examination of the keyword on the basis of the ontology. That is, the range in which a specific keyword can be used is defined, and information about the relations with the classification system can be reconstructed for each keyword using various types of information that are edited and entered by the user so that the information can be learned in the system. The reconstruction of the ontology is managed not only by the user but also by the system, and the information about the relations with the classification system of each keyword is accumulated based on such reconstructed information.

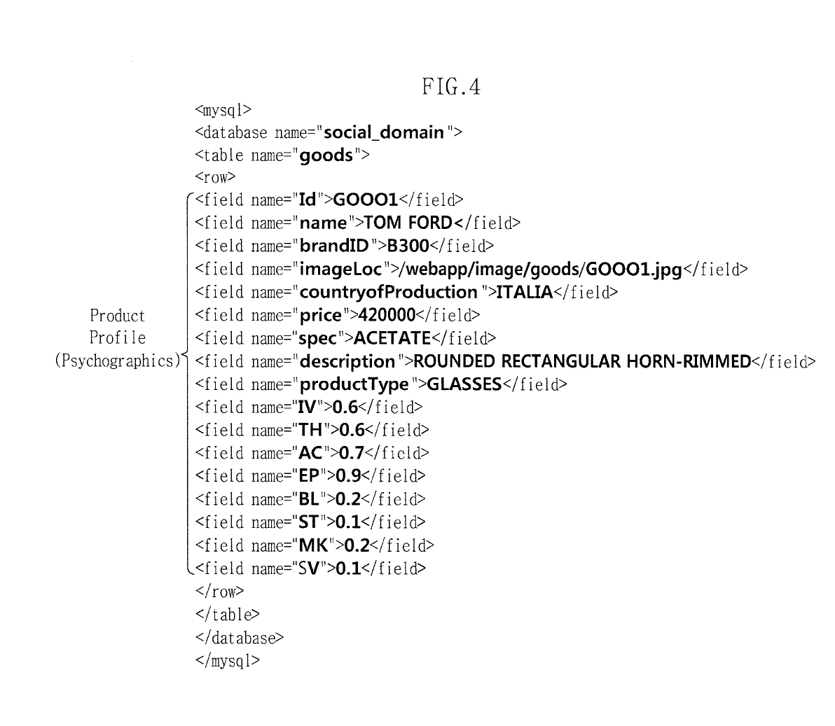

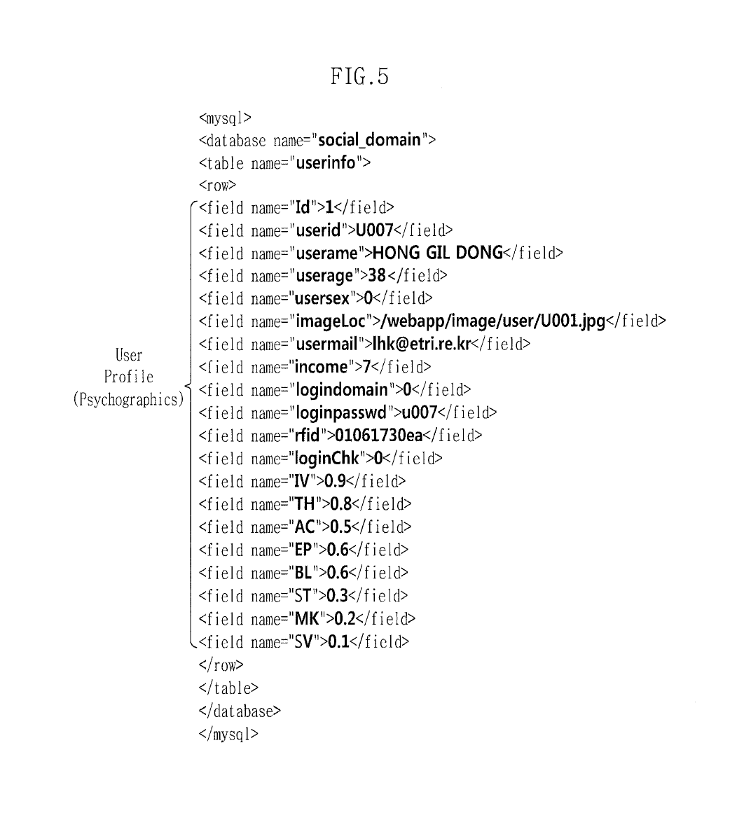

FIGS. 4 and 5 are diagrams showing schema structures for representing psychographic information provided in consideration of both the properties of a user and the characteristics of tour information from tour information provided by the automatic category generation system.

In the present invention, a structure that represents product (tour) information based on Values, Attitudes, and Life Styles (VALS) is presented in FIG. 4.

Further, as shown in FIG. 5, information that can be collected from user information can be provided by configuring eight fields [that is, IV (Innovator), TH (Thinker), AC (Achiever), EP (Experience), BL (Believer), ST (Striver), MK (Maker), and SV (Survivor)], as in the case of the embodiment depicted in the drawing. Such information is configured to perform more efficient searching by utilizing product information, which has been searched for by the user in menu items formed using the automatically generated categories, for providing customized information in which the properties of the user and the characteristics of each product are considered, rather than for providing random information.

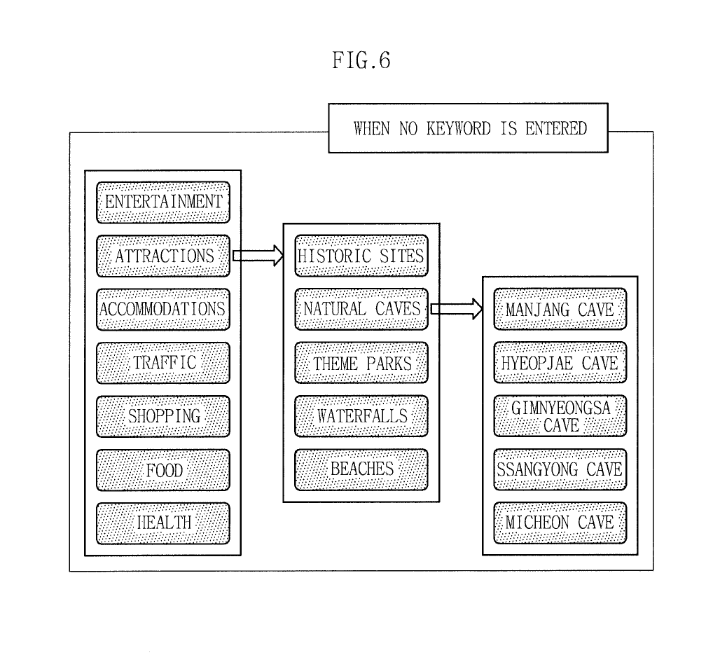

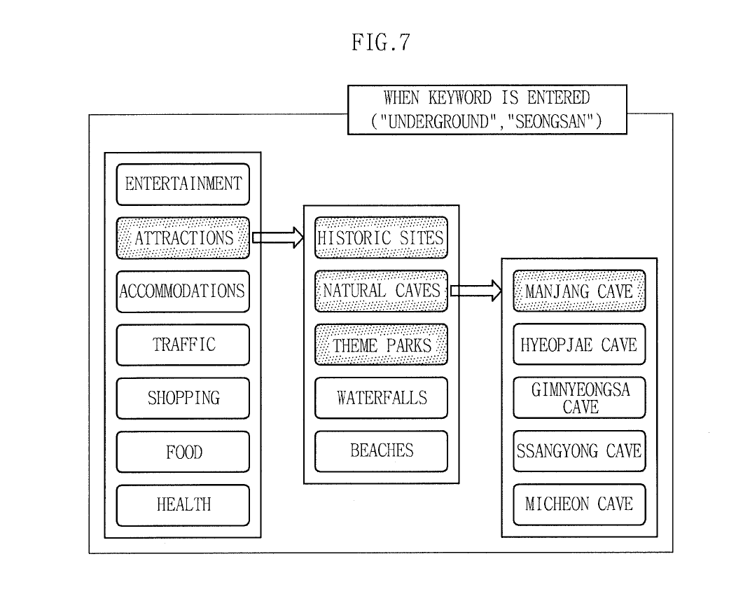

FIGS. 6 and 7 are diagrams showing examples of the transmission of menu information to a user using an automatic category generation function.

When the user does not enter a desired keyword, a structure in which the menu information is provided using a basic entire menu transmission method as shown in FIG. 6, and in which the user selects a lower menu, is provided. Such a structure is identical to a method of defining data information in advance and unilaterally providing the data information to the user.

FIG. 7 illustrates an embodiment for automatically generating categories using a keyword entered by the user according to the present invention.

The present embodiment is configured such that when “underground” is entered as a keyword, the categories that are associated with the entered keyword which was not searched for in a product information list are detected based on a keyword ontology.

Further, the locational information “seongsan” of the user is detected by accessing the user's profile, so that customized information can be provided while categories are automatically generated.

By the above procedure, categories are primarily automatically generated by entering a specific keyword, and customized information can be secondarily provided by using profile information.

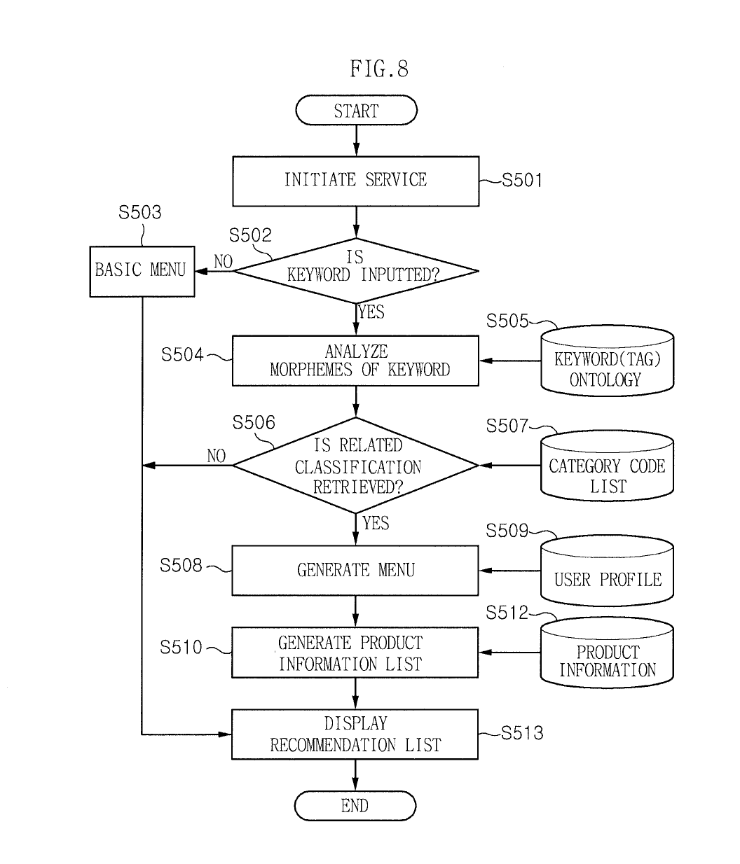

FIG. 8 is a flowchart showing a process for performing an information search method using automatic category generation provided according to the present invention.

Referring to FIG. 8, the user desires to obtain desired information using an information search service. When the user initiates the service at step S501, and inquires about relevant information, a keyword entered by the user is examined to generate a category suitable for the user at step S502. If no specific keyword has been entered, the system displays basic menu information at step S503.

In contrast, if a specific keyword has been entered, a category classification operation is initiated by analyzing the morphemes of the keyword at step S504. Whether information related to the keyword is present is detected based on the accumulated ontology relation information S505 of the keyword (tag) during a procedure for analyzing the morphemes of the keyword. When information about the relation of the detected information with a specific category is detected, a menu generation procedure is performed by inquiring about a classification system at step S506. The generation of the category is configured to complete the classification system using a code list S507 defined in a specific service environment and information classified according to the keyword at step S508.

The menu information generated during this procedure is merely obtained based on the information entered by the user, and undergoes a reprocessing procedure so that more refined menus can be generated based on the locational information and profile information S509 of the user.

Information that is to be actually provided to the user is selected based on information about locational/societal relations, and is then used to generate a product information list at step S510.

The user is provided with information about the actually desired product (commodity) from the menu, generated by the automatically generated category, on the basis of the psychographics-based user information and product information at step S513.

Some steps in the method according to the present invention may be implemented as computer-readable code on a computer-readable storage medium. The computer-readable storage medium includes all types of recording devices on which data capable of being read by a computer system is stored, and may be, for example, Read Only Memory (ROM), Random Access Memory (RAM), Compact Disc-ROM (CD-ROM), CD-ReWritable (CD-RW), a magnetic tape, a floppy disc, a Hard Disc Drive (HDD), an optical disk, and a magneto-optical storage device, etc. Further, the storage medium may also include a carrier wave form (for example, the case provided over the Internet). Furthermore, the computer-readable storage medium may be distributed across computer systems connected to each other over a network and may be stored and executed as computer-readable code in a distributed manner.

As described above, the information search system and method using automatic category generation according to the present invention is configured such that when a user enters a specific keyword, categories suitable for relevant information are automatically generated, and the searched results are provided as customized information based on locational/societal relations, thus enabling a more efficient search method to be implemented.

Further, the present invention enables an ontology for processing menu information to be constructed by collecting various types of information from a keyword entered by the user, and also enables customized menus suitable for the use of the keyword to be configured.

Thanks to the above scheme, the present invention is advantageous in that the search costs required to search for the user's desired information from menu items unilaterally supported by a service provider can be reduced, and in addition, the time required for search can be shortened and information search can be conveniently provided even when using a portable terminal such as a mobile terminal.

Further, the present invention is configured to provide an optimal menu for the user's desired information based on information having societal relations with a specific location, or to automatically generate a relevant menu by entering a specific keyword, thus minimizing the additional time and the additional information search costs that the provision of unnecessary information causes a user to have.

Furthermore, the present invention is advantageous in that it can generate a menu corresponding to any keyword when a user enters the keyword, by the automatic generation of a user-customized category, and can provide various types of information provision services from a selected menu item.

As described above, the preferred embodiments of the present invention have been disclosed. In this description, although specific terms have been used, these are only intended to describe the present invention, and are not intended to limit the meanings of the terms or the scope of the present invention as described in the accompanying claims. Therefore, those skilled in the art will appreciate that various modifications, additions and substitutions are possible, without departing from the scope and spirit of the invention. Therefore, the scope of the present invention should be defined by the technical spirit of the accompanying claims.

What is claimed is:

1. An information search method using automatic category generation, comprising:
receiving profile information and locational information of a user;
receiving a keyword from the user;
classifying a category of the received keyword by analyzing morphemes of the keyword;
generating a menu by inquiring about a classification system; and
generating a product information list using the locational information and the profile information of the user, and displaying a recommendation list based on the product information list.

2. The information search method as set forth in claim 1, further comprising detecting whether information related to the keyword is present, based on an ontology structure enabling prediction of information similar to the keyword if the keyword is not exactly identical to relevant information.

3. The information search method as set forth in claim 1, wherein the classification system is configured such that classification items are controlled to be linked to basic menus, and detailed items corresponding to each classification item are displayed.

4. The information search method as set forth in claim 1, wherein the classification system is configured in an Extensible Markup Language (XML).

5. The information search method as set forth in claim 2, wherein the classification system has a usable range of each keyword by performing analysis of morphemes of the keyword and examination of similarity, based on the ontology.

6. An information search method using automatic category generation, wherein a category related to a keyword entered by a user is automatically generated, an ontology for processing menu information is constructed based on results of search, and a customized menu suitable for a use of the keyword is provided.

7. An apparatus for automatically generating keyword-related categories, comprising:
to a user profile database (DB) for storing profile information of a user;
a locational information provision module for providing locational information of the user;
a product information DB for storing product information; and
an automatic category generation engine for generating a product information list using the information stored in the product information DB, based on the user profile information and the locational information of the user, and extracting a recommendation list based on the product information list.

8. The apparatus as set forth in claim 7, wherein the automatic category generation engine further generates:
a keyword ontology configured to enable prediction that similar information is included; and
a category code list configured to examine similarity of the keyword and automatically generate menu information.
